(19) United States
(12) Patent Application Publication
(10) Pub. No.: US 2025/0233179 A1
(43) Pub. Date: Jul. 17, 2025

(54) FUEL CELL SYSTEM

(71) Applicant: TOYOTA JIDOSHA KABUSHIKI KAISHA, Toyota-shi (JP)

(72) Inventors: Yusuke MIYAMOTO, Nisshin-shi (JP); Shuya KAWAHARA, Toyota-shi (JP); Koro FUJIO, Toyota-shi (JP)

(73) Assignee: TOYOTA JIDOSHA KABUSHIKI KAISHA, Toyota-shi (JP)

(21) Appl. No.: 18/904,093

(22) Filed: Oct. 2, 2024

(30) Foreign Application Priority Data
Jan. 12, 2024 (JP) 2024-003128

(51) Int. Cl. H01M 8/04746; H01M 10/44; H01M 10/46; H01M 16/00

(52) U.S. Cl. CPC H01M 8/04753; H01M 10/44; H01M 10/46; H01M 16/006; H01M 2220/20; H01M 2250/20

(57) ABSTRACT

The control device of the fuel cell system performs a first operation of charging the battery with the generated electric power while supplying air to the fuel cell when the target value of the generated electric power of the fuel cell is higher than the current value of the generated electric power, and performs a second operation of charging the battery with the generated electric power of the fuel cell while supplying the air with the lower flow rate than the first operation when the target value of the generated electric power is lower than the current value of the generated electric power. When an amount of charge in the battery is larger than a reference amount of charge, perform a power supply stop operation of stopping power supply from the fuel cell to the battery.

### CROSS-REFERENCE TO RELATED APPLICATION

This application claims priority to Japanese Patent Application No. 2024-003128 filed on Jan. 12, 2024, incorporated herein by reference in its entirety.

### BACKGROUND

### 1. Technical Field

The technique disclosed in the present specification relates to fuel cell systems.

### 2. Description of Related Art

A fuel cell system disclosed in Japanese Unexamined Patent Application Publication No. 2016-96086 (JP 2016-96086 A) includes a fuel cell and an air compressor. The air compressor supplies air to an air channel in the fuel cell. The fuel cell generates electric power according to required electric power from a load. The fuel cell system stops power supply to the load when the required electric power is equal to or less than a reference value. When stopping power supply to the load, the fuel cell system controls the air compressor to reduce the amount of air to be supplied to the air channel. The output voltage of the fuel cell is thus controlled to its upper limit value or less.

### SUMMARY

As described above, in the fuel cell system disclosed in JP 2016-96086 A, the air compressor supplies air to the air channel at a low flow rate while power supply to the load is stopped. This reduces an extreme decrease in output voltage of the fuel cell. However, the low flow rate may make the operation of the air compressor unstable. For example, in an air compressor with an air bearing, the air bearing floats due to the air flow. Therefore, the operation of the air compressor becomes unstable when the air flow rate is low. When the air compressor is operated at a low air flow rate, wear occurs in the air compressor. The present specification proposes a technique that reduces wear of an air compressor by reducing the frequency of a power supply stop operation in a fuel cell that charges a battery.

A fuel cell system according to a first aspect disclosed in the present specification includes:
a fuel cell;
an air channel provided in the fuel cell;
an air compressor configured to supply air to the air channel;
a battery configured to be charged by generated electric power generated by the fuel cell;
and
a control device.

The control device is configured to,
when a target value of the generated electric power is higher than a current value of the generated electric power, perform a first operation of charging the battery with the generated electric power while supplying air to the air channel by the air compressor,
when the target value of the generated electric power is lower than the current value of the generated electric power, perform a second operation of charging the battery with the generated electric power while supplying air to the air channel by the air compressor at an air stoichiometry lower than the air stoichiometry in the first operation, and
when an amount of charge in the battery is larger than a reference amount of charge, perform a power supply stop operation of stopping power supply from the fuel cell to the battery.

In the above fuel cell system, when the target value of the generated electric power is lower than the current value of the generated electric power, the control device performs the second operation, and the air compressor supplies air to the air channel at the air stoichiometry lower than that in the first operation. This reduces the power generation efficiency of the fuel cell and decreases the charging rate of the battery. As a result, the time required for the amount of charge in the battery to reach the reference amount of charge increases, so that the frequency of performing the power supply stop operation decreases. As a result, wear of the air compressor is reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a fuel cell system;

FIG. 2 is a flowchart of an operation selection process of the fuel cell system;

FIG. 3 is an explanatory diagram illustrating a relationship between an output current and an output voltage of a fuel cell;

FIG. 4 is an explanatory diagram showing the relationship between the generated electric power of the fuel cell and the amount of charge in the battery when the target value of the generated electric power of the fuel cell is larger than the current value of the generated electric power of the fuel cell; and

FIG. 5 is an explanatory diagram illustrating a relationship between the generated electric power of the fuel cell and the amount of charge of the battery when the target value of the generated electric power of the fuel cell is lower than the current value of the generated electric power of the fuel cell.

### DETAILED DESCRIPTION OF EMBODIMENTS

Following the above first aspect, additional configurations of the fuel cell system disclosed in the present specification will be described below.

### Second Aspect

The fuel cell system of the first aspect, the fuel cell includes a plurality of cells. The control device is configured to perform the first operation when the target value of the generated electric power is lower than the current value of the generated electric power and a variation in an output voltage among the cells is larger than a reference value.

### Third Aspect

In the fuel cell system of the first or second aspect, the control device is configured to perform the first operation when the target value of the generated electric power is lower than the current value of the generated electric power and an upper limit voltage is higher than an output voltage of the fuel cell.

### Fourth Aspect

In the fuel cell system of any one of the first to third aspects, the amount of charge in the battery increases during the second operation.

### Fifth Aspect

In the fuel cell system of any one of the first to fourth aspects, the amount of charge in the battery decreases during the power supply stop operation.

According to the second aspect, deterioration of the cell can be suppressed.

According to the third aspect, deterioration of the cell can be suppressed.

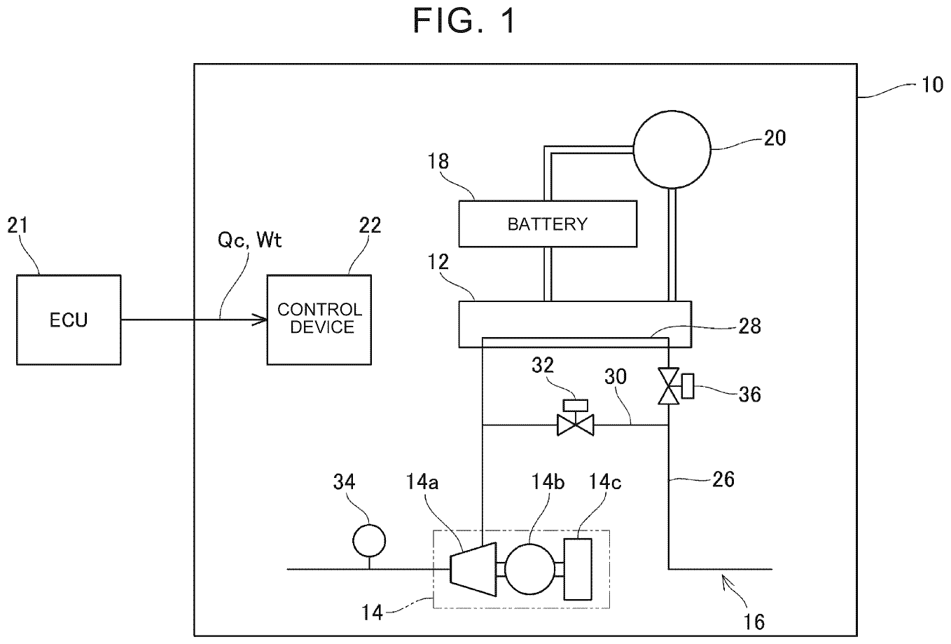

The fuel cell system is mounted on a device that uses a fuel cell as a power source. The fuel cell system 10 of the embodiment shown in FIG. 1 is mounted on a fuel cell electric vehicle. The fuel cell system 10 includes a fuel cell 12, a battery 18, and a motor 20. The motor 20 is a type of load that is supplied with electric power from the fuel cell 12 and the battery 18. The motor 20 is driven by electric power supplied from the fuel cell 12 and the battery 18 to rotate the driving wheels of fuel cell electric vehicle.

The fuel cell 12 has a configuration in which a plurality of cells is stacked. Each cell is connected in series. The fuel cell 12 is connected to the battery 18 and the motor 20. Air is supplied to the fuel cell 12 through an air channel 16, which will be described later, and hydrogen is supplied through a hydrogen channel, which is not shown. The fuel cell 12 generates electric power by reacting oxygen with hydrogen. The fuel cell 12 supplies power to the battery 18 and the motor 20.

The battery 18 is connected to the fuel cell 12 and the motor 20. The battery 18 is charged by electric power supplied from the fuel cell 12. The battery 18 supplies electric power to the motor 20.

The motor 20 is connected to the fuel cell 12 and the battery 18. The motor 20 is driven by receiving electric power from the fuel cell 12 and the battery 18.

The fuel cell system 10 includes an air compressor 14 and an air channel 16. The air compressor 14 and the air channel 16 supply air to the fuel cell 12.

The air channel 16 includes an internal channel 28 provided inside the fuel cell 12, a supply channel 24 connected to the internal channel 28, and a discharge channel 26. The supply channel 24 is connected to the upstream end of the internal channel 28. The air compressor 14 is provided in the supply channel 24. The air compressor 14 pressurizes the air in the supply channel 24 and delivers it to the downstream side. When the air compressor 14 is driven, air is supplied to the internal channel 28 through the supply channel 24. An airflow meter 34 is provided in the supply channel 24. The airflow meter 34 detects a flow rate of air flowing through the supply channel 24. The discharge channel 26 is connected to the downstream end of the internal channel 28. The air that has passed through the internal channel 28 is discharged to the outside via the discharge channel 26. A pressure regulating valve 36 is provided in the discharge channel 26. By adjusting the opening degree of the pressure regulating valve 36, the pressure in the internal channel 28 is adjusted.

The air channel 16 has a bypass channel 30. The bypass channel 30 is connected to the supply channel 24 on the downstream side of the air compressor 14 and the discharge channel 26 on the downstream side of the pressure regulating valve 36. A flow dividing valve 32 is provided in the bypass channel 30. The flow dividing valve 32 opens and closes the channel of the bypass channel 30. When the flow dividing valve 32 is in the open state, the air in the supply channel 24 branches into the internal channel 28 and the bypass channel 30 and flows. When the opening degree of the flow dividing valve 32 is adjusted, the flow rate of the air flowing through the bypass channel 30 is adjusted, so that the flow rate of the air flowing through the internal channel 28 is adjusted.

The air compressor 14 includes an air compressor body 14a, a motor 14b, and an inverter 14c. The air compressor body 14a incorporates a rotor and air bearings that support the rotor. The motor 14b rotates the rotor of the air compressor body 14a. The inverter 14c supplies a current to the motor 14b to drive the motor 14b. When the motor 14b rotates the rotor, the air compressor 14 pressurizes the air in the supply channel 24 and feeds the air to the downstream side. By controlling the rotational speed of the motor 14b, the flow rate of the air flowing to the air compressor 14 is controlled.

Electronic control unit (ECU) 21 is mounted on fuel cell electric vehicle. Further, the fuel cell system 10 includes a control device 22.

ECU 21 calculates a target value Wt of the generated electric power of the fuel cell 12 based on an operation amount of the accelerator, an operation amount of the brakes, an operation state of the motor 20, a state of charge (SOC) of the battery 18, and the like. The amount of charge of the battery 18 (hereinafter, sometimes referred to as an amount of charge Qc) is calculated based on the charge/discharge current of the battery 18. The ECU 21 inputs the target value Wt of the generated electric power of the fuel cell 12 to the control device 22.

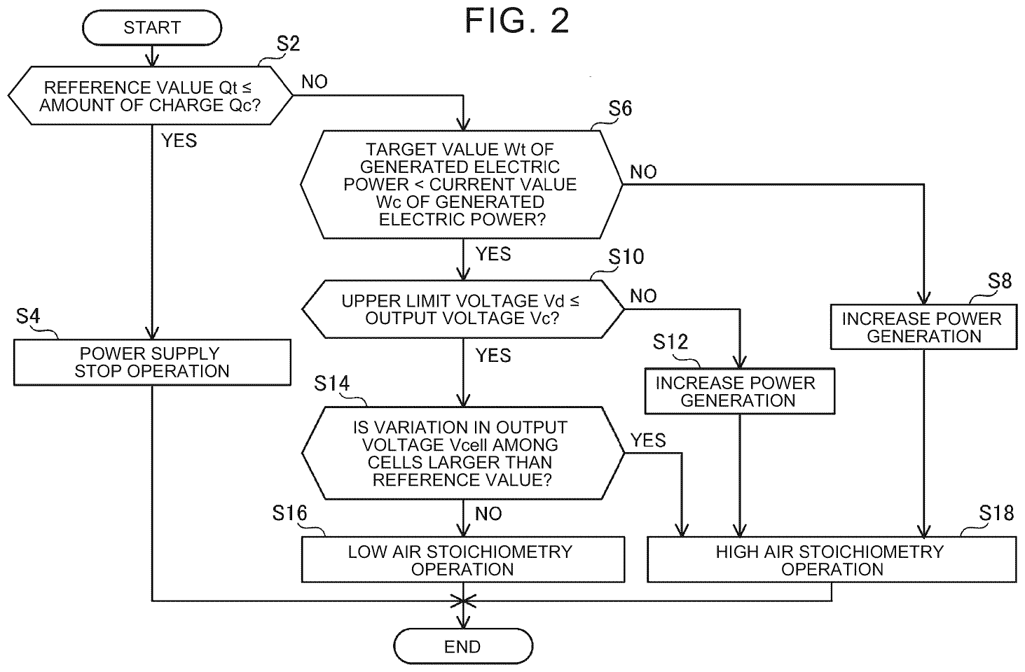

The control device 22 is connected to an inverter 14c of the air compressor 14. The control device 22 controls the air compressor 14 by controlling the inverter 14c. The control device 22 receives the target value Wt, the amount of charge Qc, etc. from the ECU 21. The control device 22 executes a high air stoichiometry operation, a low air stoichiometry operation, and a power supply stop operation on the basis of the amount of charge Qc and the target value Wt. The low air stoichiometry operation is an operation of generating electric power of the fuel cell 12 at an air stoichiometry lower than that in the high air stoichiometry operation. The power supply stop operation is an operation of stopping power supply from the fuel cell 12 to the battery 18. The fuel cell 12 selects operation according to the flowchart of FIG. 2.

In S2, the control device 22 determines whether or not the amount of charge Qc is equal to or greater than the reference amount of charge Qt.

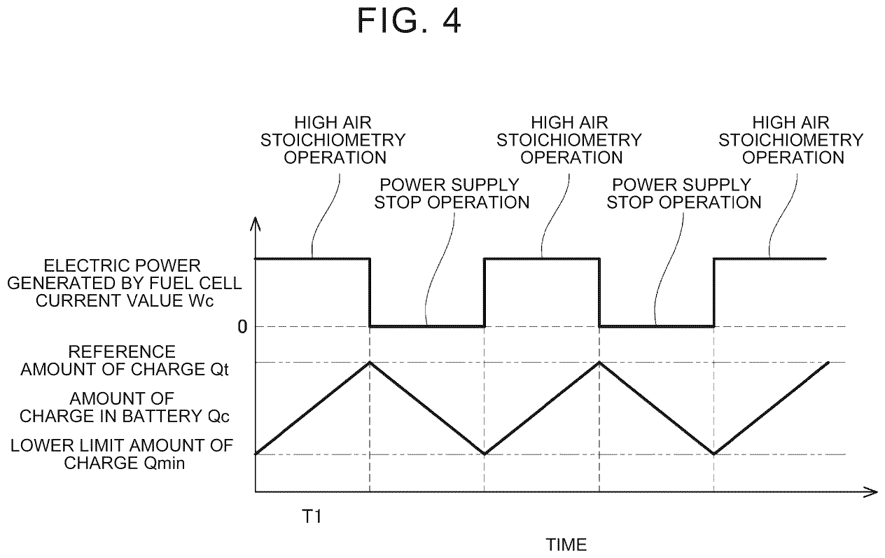

When the amount of charge Qc is equal to or greater than the reference amount of charge Qt, the control device 22 performs a power supply stop operation in S4. The power supply stop operation is an operation of stopping power supply from the fuel cell 12 to the battery 18. In the power supply stop operation, the control device 22 controls the air compressor 14 to control the flow rate of the air in the internal channel 28 to an extremely low flow rate. As a result, the generated electric power of the fuel cell 12 is reduced. Therefore, the supply of electric power to the battery 18 is stopped, and the charging of the battery 18 is stopped. Note that in the power supply stop operation, the connection between the fuel cell 12 and the battery 18 may be interrupted or the connection between the fuel cell 12 and the motor 20 may be interrupted by a switch (not shown). In the power supply stop operation, in order to suppress an extreme decrease in the output voltage of the fuel cell 12, air at a low flow rate is caused to flow through the internal channel 28. Therefore, the air compressor 14 operates in a state where the flow rate of the air is low, and wear occurs in the air compressor 14. In particular, in air compressors with air bearings, wear occurs significantly. The control device 22 performs the power supply stop operation until the amount of charge Qc falls below its lower limit Qmin (see FIG. 4).

When the amount of charge Qc is less than the reference amount of charge Qt (NO in S2), the control device 22 makes a determination in S6, S10, S14, and executes either the high air stoichiometry operation (S18) or the low air stoichiometry operation (S16) according to the determination result.

In S6, the control device 22 determines whether the target value Wt is higher than the current value Wc of the generated electric power of the fuel cell 12. When the target value Wt is higher than the current value Wc, the control device 22 raises the generated electric power of the fuel cell 12 in S8, and then performs the high air stoichiometry operation in S18.

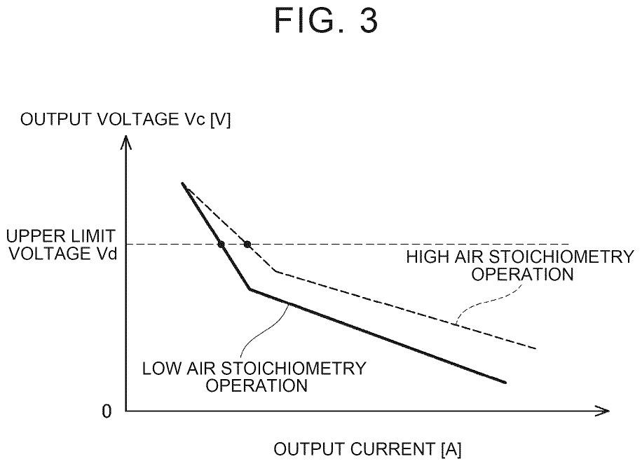

When the target value Wt is lower than the current value Wc, the control device 22 determines whether the upper limit voltage Vd (see FIG. 3) of the fuel cell 12 is equal to or lower than the output voltage Vc in S10. FIG. 3 shows the relation between the output current and the output voltage Vc of the fuel cell 12. FIG. 3 shows two graphs when the fuel cell 12 is operated at a low air stoichiometry and a high air stoichiometry. In either case, since the output voltage Vc increases as the output current decreases, the output voltage Vc may exceed the upper limit voltage Vd when the output current decreases. Further, the higher the air stoichiometry, the higher the output voltage Vc tends to be. When the output voltage Vc exceeds the upper limit voltage Vd, the electrode (for example, carbon) inside the fuel cell 12 is easily deteriorated. The control device 22, when the upper limit voltage Vd is higher than the output voltage Vc, the control device 22 increases the generated electric power of the fuel cell 12 at S12, then performs a high air stoichiometry operation at S18. In this case, the output voltage Vc does not exceed the upper limit voltage Vd even if the generated electric power is increased because the upper limit voltage Vd is higher than the output voltage Vc.

When the upper limit voltage Vd is equal to or lower than the output voltage Vc, the control device 22 acquires the output voltage Vcell of the cells (that is, the cells connected in series) of the fuel cell 12 in S14. Further, the control device 22 determines whether the variation of the output voltage Vcell is larger than the reference value. The control device 22 performs a high air stoichiometry operation in S18 when the variation in the output voltage Vcell is larger than the reference value. When the variation in the output voltage Vcell is less than or equal to the reference value, the control device 22 performs the low air stoichiometry operation in S16.

In the high air stoichiometry operation of S18, the control device 22 generates power in the fuel cell 12 while supplying air to the internal channel 28 at a high flow rate. That is, the control device 22 supplies air to the internal channel 28 at a high flow rate by operating the air compressor 14 at a high output, and generates electric power with a high air stoichiometry in the fuel cell 12. In the high air stoichiometry operation, power generation is performed with high power generation efficiency.

In the low air stoichiometry operation of S16, the control device 22 generates power in the fuel cell 12 while supplying air to the internal channel 28 at a lower flow rate than the high air stoichiometry operation. That is, the control device 22 supplies air to the internal channel 28 at a low flow rate by reducing the output of the air compressor 14 to a value smaller than in the high air stoichiometry operation, and generates electric power at a low air stoichiometry in the fuel cell 12. In the low air stoichiometry operation, power generation is performed with a power generation efficiency lower than that of the high air stoichiometry operation. The flow rate of the air flowing to the air compressor 14 in the low air stoichiometry operation is larger than the flow rate of the air flowing to the air compressor 14 in the power supply stop operation. Therefore, wear of the air compressor 14 is less likely to occur in the low air stoichiometry operation.

Next, the operation of the fuel cell system 10 when the target value Wt is higher than or lower than the current value Wc will be described. FIG. 4 shows a change in the generated electric power and the amount of charge Qc of the fuel cell 12 when the target value Wt is higher than the current value Wc (that is, when S6 is NO). In this situation, the control device 22 executes the high air stoichiometry operation when the amount of charge Qc decreases. During the high air stoichiometry operation, the amount of charge Qc increases at a high rate. When the amount of charge Qc reaches the reference amount of charge Qt, the control device 22 performs a power supply stop operation. The amount of charge Qc decreases during the power supply stop operation. In this way, when the target value Wt is higher than the current value Wc, the high air stoichiometry operation and the power supply stop operation are alternately performed. That is, charging of the battery 18 is performed intermittently.

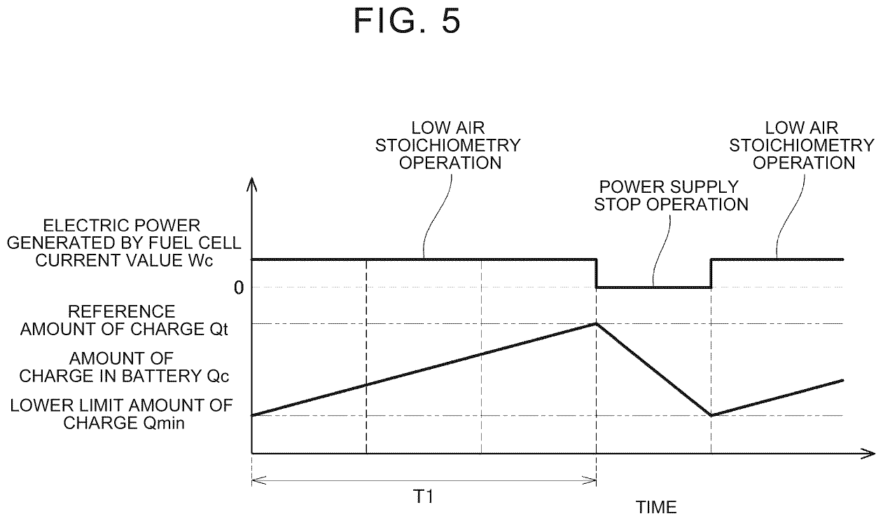

FIG. 5 shows the change in the generated electric power and the amount of charge Qc of the fuel cell 12 when the target value Wt is lower than the current value Wc (that is, when S6 is YES) and when S10 is YES, S16 and NO. In this situation, the control device 22 executes the low air stoichiometry operation when the amount of charge Qc decreases. During the low air stoichiometry operation, the amount of charge Qc increases at a lower rate than during the high air stoichiometry operation. Therefore, in the low air stoichiometry operation, the reaching time T1 until the amount of charge Qc reaches the reference amount of charge Qt is longer than in the high air stoichiometry operation. When the amount of charge Qc reaches the reference amount of charge Qt, the control device 22 performs a power supply stop operation. The amount of charge Qc decreases during the power supply stop operation. In this way, when the target value Wt is lower than the current value Wc, the low air stoichiometry operation and the power supply stop operation are alternately performed.

The reaching time T1 is longer when the air stoichiometry operation is lower than when the air stoichiometry operation is higher. Therefore, when the low air stoichiometry operation is executed, the frequency of the power supply stop operation is less than when the high air stoichiometry operation is executed. Therefore, wear of the air compressor 14 can be suppressed.

In addition, if the flow rate is decreased to such an extent that the variation in the output voltage Vcell occurs, the platinum catalyst in the cell of the fuel cell 12 deteriorates. On the other hand, as described above, the control device 22 performs the high air stoichiometry operation when the variation in the output voltage Vcell is larger than the reference value in S14. Therefore, deterioration of the platinum catalyst can be suppressed.

Further, as described above, when the upper limit voltage Vd is higher than the output voltage Vc in S10, the control device 22 performs the high air stoichiometry operation by increasing the power generation. As a result, power generation can be performed while the output voltage Vc is close to the upper limit voltage Vd, and thus the power generation efficiency can be improved.

Further, in the above embodiment, the flow rate of the air in the internal channel 28 is decreased by decreasing the output of the air compressor 14 in the low air stoichiometry operation. However, in the low air stoichiometry operation, the flow rate of the air in the internal channel 28 may be reduced by increasing the opening degree of the flow dividing valve 32.

The high air stoichiometry operation of the embodiment is an example of the first operation. The low air stoichiometry operation of the embodiment is an example of the second operation.

While the embodiments have been described in detail above, these are merely illustrative and do not limit the scope of the claims. The technology described in the claims includes various modifications and alterations of the specific examples described above. The technical elements described in this specification or in the drawings may be used alone or in various combinations, and are not limited to the combinations described in the claims at the time of filing. Further, the technology illustrated in the present specification or the drawings achieves a plurality of objects at the same time, and has technical usefulness by achieving one of the objects.

What is claimed is:

1. A fuel cell system, comprising:
a fuel cell;
an air channel provided in the fuel cell;
an air compressor configured to supply air to the air channel;
a battery configured to be charged by generated electric power generated by the fuel cell; and
a control device, wherein the control device is configured to,
when a target value of the generated electric power is higher than a current value of the generated electric power, perform a first operation of charging the battery with the generated electric power while supplying air to the air channel by the air compressor,
when the target value of the generated electric power is lower than the current value of the generated electric power, perform a second operation of charging the battery with the generated electric power while supplying air to the air channel by the air compressor at an air stoichiometry lower than the air stoichiometry in the first operation, and
when an amount of charge in the battery is larger than a reference amount of charge, perform a power supply stop operation of stopping power supply from the fuel cell to the battery.

2. The fuel cell system according to claim 1, wherein:
the fuel cell includes a plurality of cells, and
the control device is configured to perform the first operation when the target value of the generated electric power is lower than the current value of the generated electric power and a variation in an output voltage among the cells is larger than a reference value.

3. The fuel cell system according to claim 1, wherein the control device is configured to perform the first operation when the target value of the generated electric power is lower than the current value of the generated electric power and an upper limit voltage is higher than an output voltage of the fuel cell.

4. The fuel cell system according to claim 1, wherein the amount of charge in the battery increases during the second operation.

5. The fuel cell system according to claim 1, wherein the amount of charge in the battery decreases during the power supply stop operation.
